(19) United States
(12) Patent Application Publication
(10) Pub. No.: US 2009/0026811 A1
(43) Pub. Date: Jan. 29, 2009

(54) Support Structure for a Seat with a Table Function and Corresponding Seat Suspension Arrangement

(75) Inventors: Maxime Samain, Lauwe (BE); Jo Patlyn, Geluwe (BE); Pierrot Catry, Spiere (BE); David Moyaert, Roeselare (BE)

Correspondence Address: KANG INTELLECTUAL PROPERTY LAW, LLC, 214 ELM STREET, SUITE 106, WASHINGTON, MO, 63090, US

(73) Assignee: L&P SWISS HOLDING COMPANY, Wittenbach (CH)

(21) Appl. No.: 11/813,896

(22) PCT Filed: Dec. 29, 2005
(86) PCT No.: PCT/EP05/14118

§ 371 Date: Aug. 28, 2008

(30) Foreign Application Priority Data
Jan. 19, 2005 (EP) 05001004.0

(51) Int. Cl. B60N 2/66; A47C 7/46; A47B 85/04; B60N 2/20

(52) U.S. Cl. 297/125; 297/284.4

(57) ABSTRACT

In a seat with a table function, an upper portion of the backrest can be pivoted forward so as to bring a back surface of the backrest into a horizontal position so that it can be used as a table. A support structure (2) in the form of an articulated suspension is provided which provides support for upholstery of the seat and at the same time also gives the necessary freedom to the backrest to be pivoted forward. The support structure (2) comprises a first portion (2a) and a second portion (2b) which are connected so as to be pivotable with respect to each other. Both the first portion (2a) and the second portion (2b) are essentially formed of a wire framework consisting of a pair of lateral side wires (4a, 4b) and transverse wires (8a, 8b) extending between the lateral side wires (4a, 4b).

The present invention relates to a support structure for a seat with a table function. In particular, the invention relates to a support structure for incorporation into a seat frame, the support structure forming an articulated suspension for providing load bearing support for upholstery of the seat.

It is known to provide a seat with a table function by providing the backrest of the seat with an axis of articulation such that the upper part of the backrest of the seat can be pivoted forward, a rear surface of the backrest then coming into a horizontal position for functioning as a table. The axis of articulation typically extends parallel to the base of the seat at a position somewhere above the base of the seat such that a suitable height is achieved for the table. This can for example be taken from patent publication US 2004/0183353 A1, which relates to a seat which can be folded into a position allowing for the rear surface of the backrest to be used as a table. This type of seat is particularly utilized in vehicles.

From patent publication GB 2 342 287 A a support structure for providing a load bearing support for upholstery of the seat is known which comprises a wire framework having two lateral side wires between which extends a plurality of transverse wires. This known support structure is arranged to be suspended in a seat frame by means of springs, for example, which may be connected to hook-like fingers extending from the wire framework.

However, in case of the seat having a table function as described above, the known types of support structures cannot be made to extend all over the backrest, i.e. the vertical portion of the seat, as this would interfere with the additional axis of articulation provided in the backrest. Therefore, comfort cannot be provided in a continuous manner all along the backrest.

It is an object of the present invention to provide a support structure which is suitable for use in a seat with a table function and which provides comfortable support in a continuous manner along the backrest of the seat.

According to the present invention, this object is achieved by a support structure for a seat with a table function according to independent claim 1. The dependent claims define preferred and advantageous embodiments of the present invention.

The support structure of the present invention comprises a first portion having a pair of first lateral side wires and a plurality of first transverse wires extending between the pair of first lateral side wires and the second portion having a pair of second lateral side wires and at least one second transverse wire. The first portion and the second portion are connected so as to be pivotable with respect to each other about a transverse axis. The support structure of the present invention can therefore be arranged to extend substantially all along the backrest of a seat, thereby providing a continuous support. At the same time, the required freedom for pivoting the upper part of the backrest into a vertical position is provided.

The pivotable connection between the first portion and the second portion is preferably provided by including an end portion transverse wire extending between end portions of the first lateral side wires and by forming end portions of the second lateral side wires each into a loop extending around the end portion transverse wire. Of course, it is also possible to provide the end portion transverse wire between the end portions of the second lateral side wires and to form the end portions of the first lateral side wires each into a loop extending around the end portion transverse wire. The loop can be a closed loop or an open loop and can be formed in a simple manner by bending the end portions of the respective wires. At the same time, the end portion transverse wire gives additional strength to the portion of the support structure in which it is provided. Accordingly, the pivotable connection between the first portion and the second portion of the support structure can be provided in a very efficient manner which at the same time increases the strength of the support structure.

The end portion transverse wire can be integrally formed with the lateral side wires between the end portions of which it is provided.

According to a preferred embodiment, the end portion transverse wire is provided as a separate wire and connected to the respective lateral side wires by means of connecting portions of the end portion transverse wire, the connecting portions being formed in the end portion transverse wire so as to extend in parallel to the lateral side wires to which it is connected. The connection is then preferably achieved by fitting a tubular member around the connecting portion and the respective lateral side wire. Of course, also other methods of connecting the end portion transverse wire to the lateral side wires are possible. By means of providing the connecting portions in parallel to the lateral side wires an improved strength of the connection is achieved.

The first transverse wires and also the second transverse wires may comprise at least at one of their ends an elongated end portion which extends laterally beyond the respective lateral side wire which is located on the side of the end of the transverse wire. In a similar manner, also the end portion transverse wire may comprise at least one elongated end portion. The elongated end portions may be used for attaching the support structure to a seat frame. For this purpose the elongated end portions may be formed as hook-like fingers for easily attaching the support structure to the seat frame. Alternatively, the elongated end portions may terminate in free ends which extend beyond the lateral side wires and can flex independently of one another relative to a portion of the wire framework bounded by the two lateral side wires. In particular, such laterally extending free ends can be used for providing an adjustable lumbar support in a lower portion of the backrest.

In general, the wires of the support structure may have different diameters. In particular, the diameters of the first and second transverse wires may differ from that of the end portion transverse wire and also from that of the lateral side wires. Also, the wire diameters of the first portion of the support structure may be selected independently from the wire diameters of the second portion of a support structure.

In the following, the present invention will be described in detail in conjunction with the drawings and with reference to preferred embodiments.

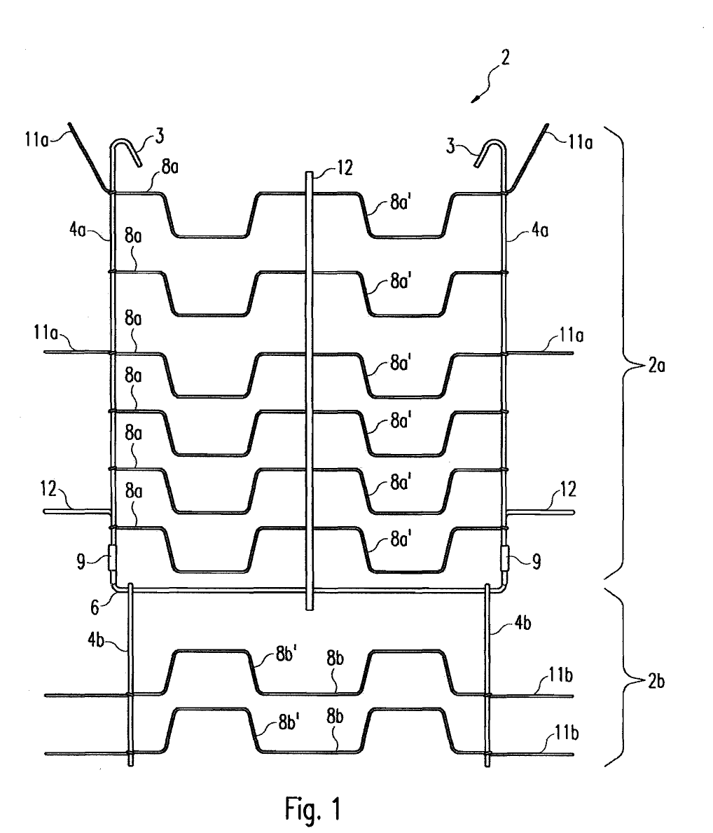

FIG. 1 is a front view of a support structure for a seat with a table function in accordance with a preferred embodiment of the present invention,

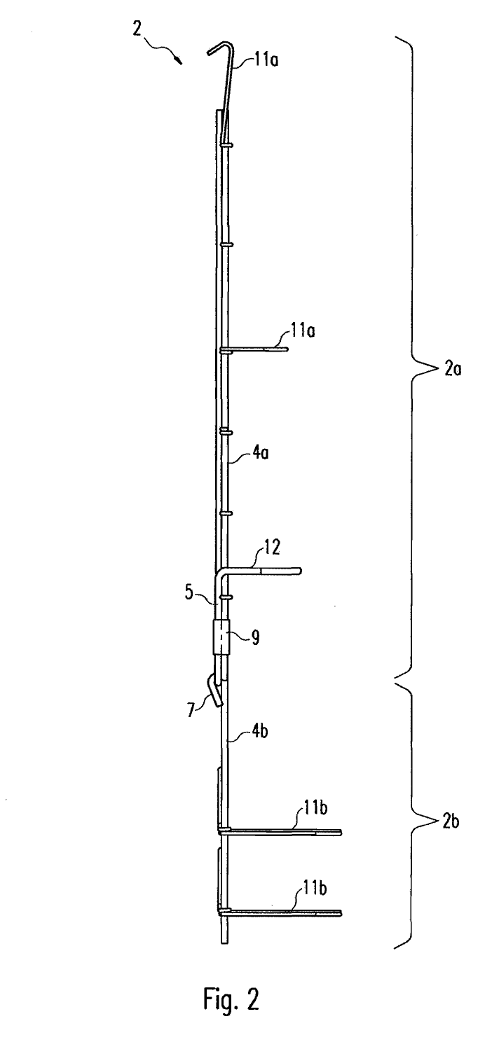

FIG. 2 is a side view of the support structure shown in FIG. 1,

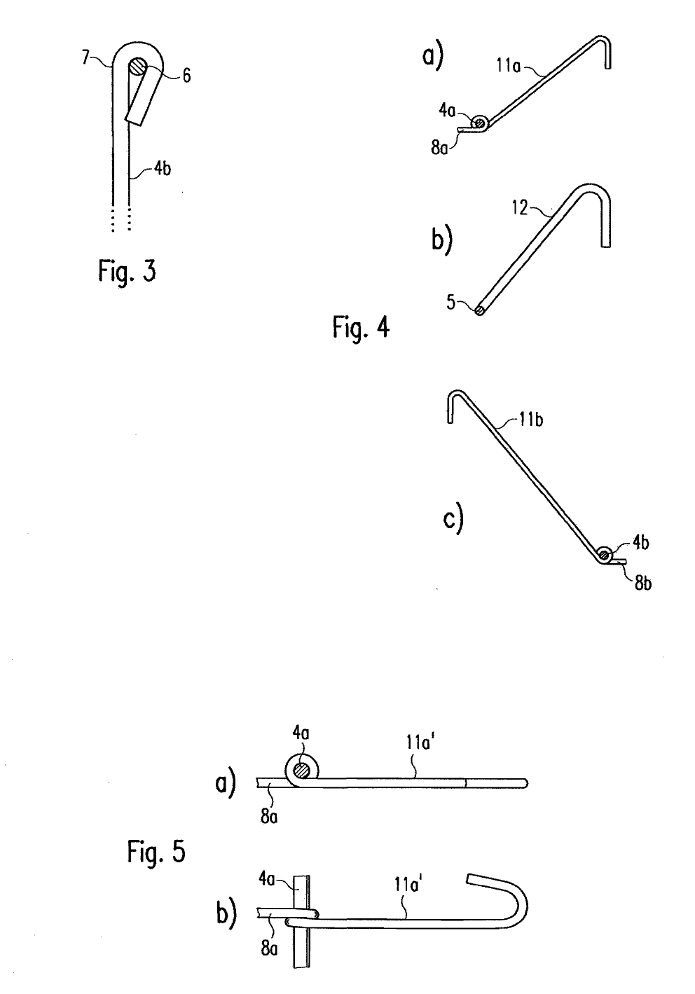

FIG. 3 is an enlarged view of a connection between a first portion and a second portions of the support structure shown in FIGS. 1 and 2, and

FIG. 4(a), (b), and (c) show enlarged partial views of an elongated end portion of a transverse wire of the first portion of the support structure, an elongated end portion of an end portion transverse wire of the support structure, and an end portion of a transverse wire of the second portion of the support structure, respectively.

FIGS. 5(a) and (b) show an alternative configuration of the elongated end portion of FIG. 4(a).

FIG. 1 shows an articulated support structure 2 for incorporation into a seat frame of a seat having a table function. In general, the seat frame of a seat having a table function will be configured to allow for pivoting an upper part of a backrest of the seat into a forward direction such that a rear surface of the backrest attains a substantially horizontal position and can be used as a table. The support structure may also be designed as a suspension mat or a pad. The support structure is in particular adapted to provide support for upholstery of the seat. The seat may in particular be configured as a vehicle seat.

The support structure 2 comprises a first portion 2a and a second portion 2b. The first portion 2a and the second portion 2b are connected so as to be pivotable with respect to each other about a transverse axis. As used herein, a transverse direction refers to a direction extending in the plane of the support structure 2, from left to right in FIG. 1, whereas a longitudinal direction extends from the bottom to the top of the support structure 2 shown in FIG. 1.

The first portion 2a of the support structure 2 comprises a pair of first lateral side wires or side rails 4a which are interconnected by a plurality of first transverse wires 8a extending between the first lateral side wires 4a. The first transverse wires 8a are anchored or attached to the first lateral side wires 4a by being wound around the latter. The first transverse wires 8a have angled portions 8a′ which generally extend in the plane of the support structure as illustrated and form trapezoidal sections. The angled portions 8a′ allow for an extension of the support structure under a load which is exerted thereon. Furthermore, the first transverse wires 8a extend through a center cord 12 of paper or synthetic plastic material which serves to maintain a predefined vertical spacing between the first transverse wires 8a. The center cord may also have the form of a tube.

The second portion 2b of the support structure 2 is configured in a similar manner as the first portion 2a. In particular, the second portion 2b comprises a pair of second lateral side wires or side rails 4b which are interconnected by at least one second transverse wire 8b. In the embodiment shown in FIG. 1, the second portion 2b comprises two second transverse wires 8b. It will be appreciated that, depending on the characteristics of the seat, other numbers of transverse wires and different spacings thereof may be selected both for the first portion 2a and for the second portion 2b. In particular, the second portion 2b may also be provided with a plurality of the second transverse wires 8b and may also have a center cord similar to the center court 12 of the first portion 2a. Also, the diameters of the first and second transverse wires 8a, 8b can be selected depending on the desired stiffness of the support structure 2 in specific regions. As can be seen from FIG. 1, the spacing of the first transverse wires 8a is smaller in a lower portion of the first portion 2a of the support structure 2. This lower portion may in particular correspond to a lumbar region of the seat. By means of the closer spacing of the transverse wires 8a, an enhanced stiffness of the support structure is achieved in the lumbar region. In the support structure 2 as illustrated in FIG. 1, the first portion 2a is to be arranged in an upper portion of the backrest whereas the second portion 2b is to be arranged in a lower portion of the backrest.

The transverse wires 8a, 8b are anchored to the respective lateral side wires 4a, 4b by being wound around the latter. Some of the transverse wires 8a and both transverse wires 8b terminate in elongated end portions 11a, 11b which extend beyond the respective lateral side wire 4a, 4b. These elongated end portions 11a, 11b may serve to attach the support structure 2 to the seat frame (not shown in FIG. 1). In particular, some or all of these elongated end portions 11a, 11b may be formed into hook-like fingers which can be used to easily attach the support structure 2 to the seat frame. The hooks may extend both in the support plane of the support structure 2 and perpendicular thereto or in any other desired direction with respect to the support plane, as required for mounting the support structure on the seat frame. Of course, some of the elongated end portions 11a, 11b may also constitute free ends that can flex independently of one another relative to a portion of the wire framework constituted by the wires 8a, 8b and bounded by the lateral side wires 4a, 4b. Some of the first transverse wires 8a of the first portion 2a terminate substantially at the respective lateral side wires 4a.

At the lower end portions of the first lateral side wires 4a, an end portion transverse wire 6 is provided, which extends between the end portions of the first lateral side wires 4a. The end portion transverse wire 6 has a diameter which essentially corresponds to the diameter of the first lateral side wires 4a and is connected to the first lateral side wires 4a by means of connecting portions extending in parallel to the first lateral side wires 4a. Alternatively, the end portion transverse wire 6 may also have a diameter which is different from that of the lateral side wires 4a, e.g. is smaller or longer than the diameter of the lateral side wires 4a. The connecting portions connect at both sides to a center portion of the end portion transverse wire 6, which extends between the first lateral side wires 4a. The connecting portions are fixed to the respective lateral side wire 4a by means of a tubular member 9 fitted around the connecting portion and the respective lateral side wire 4a. An elongated end portion 12 of the end portion transverse wire 6 connects to the connecting portions. The elongated end portions 12 extend laterally beyond the respective lateral side wire 4a and are configured for attaching the support structure 2 to the seat frame by being formed as hook-like fingers.

At their upper end portion, the second lateral side wires 4b of the second portion 2b are each provided with a loop extending around the end portions transverse wire 6. By this means, the second lateral side wires 4b can be pivoted with respect to the first lateral side wires 4a. Consequently, the first portion 2a and the second portion 2b of the support structure 2 are pivotable with respect to each other. Further, the second lateral side wires 4b can be moved in a transverse direction along the end portion transverse wire 6, e.g. in response to a load exerted on the second portion 2b of the support structure. The upper end portions of the second lateral side wires may also be formed in a different shape, e.g. like a hook with a straight portion. The loop may be an open loop or a closed loop.

For attaching the support structure 2 to the seat frame, the upper end portions of the first lateral side wires 4a are provided with hooks 3. In a similar manner, also the lower end portions of the second lateral side wires 4b can be provided with hooks.

As illustrated in FIG. 1, both the first transverse wires 8a and the second transverse wires 8b have angled wire portions 8a′, 8b′ which form trapezoidal sections. The trapezoidal sections of the first portion 2a are arranged to extend downwardly relative to the respective connecting points of the first transverse wires 8a to the first lateral side wires 4a. The trapezoidal sections of the second transverse wires 8b are arranged to extend upwardly relative to the respective connecting points of the second transverse wires 8b to the second lateral side wires 4b. By this means, the longitudinal distance between a support region of the lowermost first transverse wire 8a and a support region of the uppermost second transverse wire 8b is minimized, which gives an improved continuity of the support. At the same time, the transverse wires 8a, 8b can be aligned with support holes formed in the seat frame.

FIG. 2 shows a side view of the support structure 2. As can be seen, the elongated end portions 11a, 11b of the first and second transverse wires 8a, 8b extend out of the support plane of the support structure 2. In a similar manner, also the elongated end portion 12 of the end portion transverse wire 6 extends out of the support plane. These elongated end portions 11a, 11b, 12 are formed as hook-like fingers for attaching the support structure 2 to the seat frame. Of course, the hook-like fingers can also be formed so as to extend essentially in the support plane or in another plane, as required by the geometry of the seat frame.

As shown in FIG. 2, the upper end portion of the lateral side wire 4b of the second portion 2b is provided with the loop 7 which is formed around the end portion transverse wire 6. The end portion transverse wire 6 has the connecting portion 5 which extends in parallel to the first lateral side wire 4a of the first portion 2a. The tubular member 9 is fitted around the connecting portion 5 and the lateral side wire 4a. The hook-like elongated end portion 12 of the end portion transverse wire 6 is angled out of the support plane.

FIG. 3 shows an enlarged view of the pivotable connection provided by the loop 7 formed around the end portion transverse wire 6. By this arrangement, a pivotable connection is provided between the first portion 2a and the second portion 2b of the support structure 2, which can be easily fabricated by providing the end portion transverse wire 6 as a pivot axis and bending the end portions of the second lateral side wires 4b around this pivot axis.

In FIG. 3, the loop 7 is illustrated as a closed loop which completely encloses the end portion transverse wire 6. Alternatively, the loop 7 may be formed as an open loop. While the closed loop configuration offers a higher stability of the assembled support structure 2, i.e. prevents the second portion 2b from coming off the first portion 2a, the open loop configuration facilitates the assembly of the support structure 2.

FIG. 4 shows enlarged partial views of the hook-like elongated end portions 11a, 11b, and 12 of the first transverse wires 8a, the second transverse wires 8b, and the end portion transverse wire 6, respectively.

As shown in FIG. 4(a) the first transverse wire 8a is wound in a helical manner around the first lateral side wire 4a and further extends in the form of the hook-like elongated end portion 11a. FIG. 4(b) shows the hook-like elongated end portion 12 which connects to the connecting portion 5 of the end portion transverse wire 6. FIG. 4(c) shows the second transverse wire 8b being wound around the second lateral side wire 4b and then further extending as the hook-like elongated end portion 11b.

The hook-like elongated end portions 11a, 11b, 12 are used for attaching the support structure 2 to the seat frame. For this purpose, the elongated end portion 11a, 11b, 12 may be directly hooked into the seat frame or, alternatively, coupled to the seat frame by means of tension springs anchored between the seat frame and the respective elongated end portions 11a, 11b, 12. All the hook-like elongated end portions 11a, 11b, 12 may be configured with the hooks extending in a plane which is perpendicular to the support plane, as shown in FIG. 4. Alternatively, in each case the hooks can be formed so as to extend in a different plane, i.e. the hooks may extend in a vertical plane, a horizontal plane or under an angle as compared to the support plane.

Such an alternative configuration is exemplarily illustrated in FIGS. 5(a) and (b) for the case of the first transverse wire 8a. In this alternative configuration of the elongated end portion 11a′, the hook-like finger extends substantially in parallel to the support plane, i.e. in a vertical direction.

The support structure 2 as shown in FIGS. 1 and 2 can be used to provide non-adjustable lumbar support. However, it is preferable to provide means for adjustably arching the lateral side wires 4a, 4b to enable horizontal adjustment of the support, e.g. in the lumbar region. These means may in particular comprise a Bowden cable arrangement to be actuated by a manual or electric actuating mechanism, e.g. as disclosed in U.S. Pat. No. 5,988,745 A.

The support structure 2 as described above provides a continuous load bearing support for the upholstery of the seat. By means of the hook-like elongated portions 11a, 11b, 12 the support structure 2 can be easily attached to the seat frame. Moreover, the support structure 2 responds to the particular demands of a seat with as table function. In the “seat position”, support is provided both below and above the axis of articulation which is necessary for the table function of the seat. This allows for a continuous comfort all along the backrest. At the same time, the support structure 2 allows for bringing the backrest into the “table position” by providing the backrest with the necessary freedom to be pivoted forward.

1-16. (canceled)

17. A support structure to be arranged in a backrest of a seat with a table function, comprising
a first portion to be arranged in an upper portion of the backrest and having a pair of first lateral side wires and a plurality of first transverse wires extending between the pair of first lateral side wires;
a second portion to be arranged in a lower portion of the backrest and having a pair of second lateral side wires and at least one second transverse wire;
wherein the first portion and the second portion are connected so as to be pivotable with respect to each other about a transverse axis.

18. The support structure according to claim 17,
wherein the first/second portion includes an end portion transverse wire extending between end portions of the first/second lateral side wires; and
end portions of the second/first lateral side wires are each formed as a loop extending around the end portion transverse wire.

19. The support structure according to claim 18,
wherein the end portion transverse wire is integrally formed with the first/second lateral side wires.

20. The support structure according to claim 18,
wherein the end portion transverse wire is connected to the first/second lateral side wires by means of connecting portions of the end portion transverse wire, the connecting portions extending in parallel to the first/second lateral side wires.

21. The support structure according to claim 20,
wherein a tubular member is fitted around the connecting portions of the end portion transverse wire and a respective first/second lateral side wire.

22. The support structure according to claim 20,
wherein the end portion transverse wire comprises at least at one end thereof an elongated end portion which extends laterally beyond the respective first/second lateral side wire.

23. The support structure according to claim 17,
wherein at least one of the first transverse wires comprises at least at one end thereof an elongated end portion which extends laterally beyond the respective first lateral side wire.

24. The support structure according to claim 17,
wherein at least one of the second transverse wires comprises at least at one end thereof an elongated end portion which extends laterally beyond the respective second lateral side wire.

25. The support structure according to claim 22,
wherein the elongated end portion is adapted for attaching the support structure to a seat frame.

26. The support structure according to claim 22,
wherein the elongated end portion is formed as a hook-like finger.

27. The support structure according to claim 17,
wherein the first transverse wires are attached to the first lateral side wires by being wound around the first lateral side wires.

28. The support structure according to claim 17,
wherein the at least one second transverse wire is attached to the second lateral side wires by being wound around the second lateral side wires.

29. The support structure according to claim 17,
wherein at least one of the first transverse wires comprises at least one angled wire portion between said pair of first lateral side wires.

30. The support structure according to claim 17,
wherein the at least one second transverse wire comprises at least one angled wire portion between said pair of second lateral side wires.

31. The support structure according to claim 17,
wherein the support structure is adapted to provide support for upholstery of the seat.

32. A seat suspension arrangement for a backrest of a seat with a table function, comprising:
a seat frame, and
a support structure suspended in said seat frame, the support structure comprising:
a first portion to be arranged in an upper portion of the backrest and having a pair of first lateral side wires and a plurality of first transverse wires extending between the pair of first lateral side wires;
a second portion to be arranged in a lower portion of the backrest and having a pair of second lateral side wires and at least one second transverse wire;
wherein the first portion and the second portion are connected so as to be pivotable with respect to each other about a transverse axis.
